(19) United States
(12) Patent Application Publication
(10) Pub. No.: US 2026/0036022 A1
(43) Pub. Date: Feb. 5, 2026

(54) JOYSTICK SAFETY SWITCH

(71) Applicant: Axis Energy Services, LLC, Dallas, TX (US)

(72) Inventors: Eric NEU, Lindsay, TX (US); Joe Ray HALL, Gainesville, TX (US)

(21) Appl. No.: 19/291,506

(22) Filed: Aug. 5, 2025

Related U.S. Application Data
(60) Provisional application No. 63/679,606, filed on Aug. 5, 2024.
(60) Provisional application No. 63/746,556, filed on Jan. 17, 2025.
(60) Provisional application No. 63/810,272, filed on May 22, 2025.

(51) Int. Cl. E21B 41/00

(52) U.S. Cl. CPC E21B 41/0021

(57) ABSTRACT

A method of operating a rig includes maintaining a drum of the rig in a non-rotational state. The method also includes moving a safety switch to an inactive position to activate a first electrical braking system and then a joystick is moved to rotate the drum. The method further includes moving the safety switch to an active position to cause the first braking system to apply sufficient torque to slow down and stop rotation of the drum. After slowing down the drum, the first braking system is used to retain the drum in the non-rotational state. After a predetermined period to time, a second braking system is activated to retain the drum in the non-rotational state, and the first braking system is deactivated. Before reactivating the first braking system, the joystick is returned to a neutral position.

### CROSS-REFERENCE TO RELATED APPLICATIONS

This application claims the benefit of priority of U.S. Provisional Patent Application No. 63/810,272, filed on May 22, 2025; claims the benefit of priority of U.S. Provisional Patent Application No. 63/746,556, filed on Jan. 17, 2025; and claims the benefit of priority of U.S. Provisional Patent Application No. 63/679,606, filed on Aug. 5, 2024, each of the above referenced applications is incorporated herein by reference in its entirety.

### BACKGROUND

### Field

Embodiments of the present disclosure generally relate to rigs, such as drilling or service rigs, and particularly to the control and operation of rigs.

### Description of the Related Art

Safe operation of equipment at rig site locations involves many failsafe devices and methods to automatically close, open, start, and stop equipment or operations to mitigate or eliminate potential damage to the equipment or harm to personnel. One of the most dangerous locations to be is on a rig floor where lifting and lowering of heavy objects such as tubulars and rotating of various devices could result in injury or damage.

While many rigs use electronic controls for rig operations, the rigs may still include some form of manual operation. For example, an operator may be required to operate a control lever on the rig for certain operations.

There is a need, therefore, for an electronic control lever to include an automatic shutoff switch on the control lever to automatically stop rig operations.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of the scope of the disclosure, as the disclosure may admit to other equally effective embodiments.

FIG. 1 shows an exemplary electric service rig and a service trailer connected by communication and power lines, according to some embodiments.

FIG. 2 is an enlarged, partial view of the service rig of FIG. 1, including details about the drawworks.

FIG. 3 shows an exemplary control panel including a joystick and a safety button, according to some embodiments.

FIG. 4 shows an exemplary mechanical braking system, in the inactivated mode, according to some embodiments.

FIG. 5 shows the mechanical braking system of FIG. 4 in the activated mode.

### DETAILED DESCRIPTION

In some embodiments, a rig includes one or more sensor switches as a failsafe device to operate equipment. For example, sensor switches may be used to detect the proximity of an operator either too close or too far away for safety, whether the operator is standing, sitting, or falling, or whether the operator is touching or applying pressure to a device. The device may be a control lever for controlling a variety of rig operations. The control lever may control lifting and lowering of a drawworks hook and other moving rig operations. In some embodiments, the control lever includes an automatic shutoff switch on the control lever to automatically stop one or more operations in the event the operator's hand operating the control lever is removed from the control lever and/or a switch on the control lever.

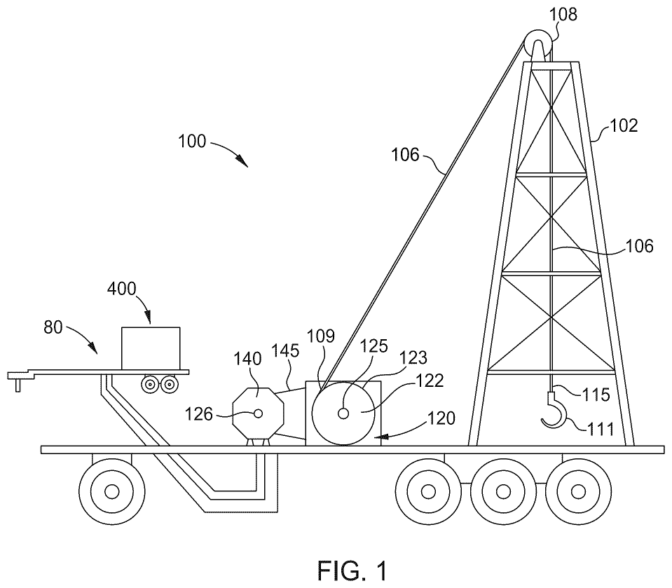

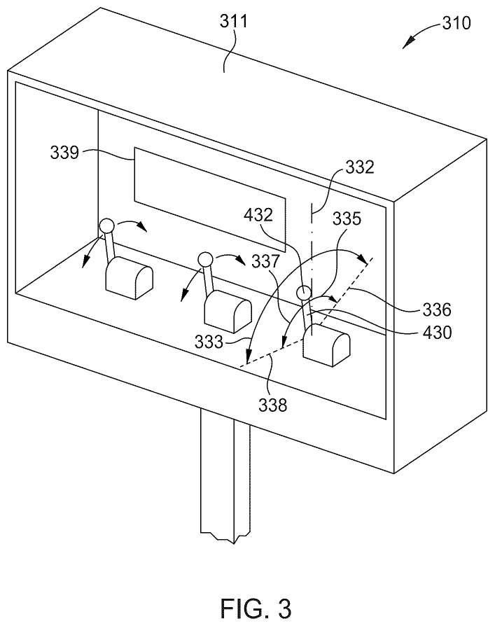

Embodiments of the present disclosure relate to an automatic safety device to stop operations and/or to implement other operations on a service rig 100, as shown in FIG. 1. In some examples, the automatic safety device includes a safety switch 432 that can move between an active position and an inactive position, as shown in FIG. 3. The position of the safety switch 432 can be used to control operations of the service rig 100. In some embodiments, the active position of the safety switch 432 means safety procedures have been implemented. The inactive position of the safety switch 432 means one or more rig operations on the service rig 100 are allowed to function. The safety switch 432 may be moved to the active position either intentionally or unintentionally by an operator's removal of the hand. In some embodiments, the safety switch 432 may be biased towards the active position. The safety switch 432 may open a circuit when in the active position and close a circuit when in the inactive position, or vice versa.

The safety switch 432 interacts with a control system 400 to control operations on the service rig 100. The control system 400 may be located on a service trailer 80 and includes a variable frequency drive and programmable logic controllers. When the safety switch 432 is in the inactive position, the control system 400 may allow one or more rig operations on the service rig 100 to function. Exemplary operations include rotation of an electric motor 140 and a rotatable drum 122 of a drawworks 120 or braking of the drum 122. The rig operation may be selected by an operator when performing a service activity. Another example of a rig operation is operating rotational devices for tubulars such as a rotary table or top drive, not shown. When the safety switch 432 is in the active position, the control system 400 gives commands to automatically stop certain rig operations and implement other operations on the service rig 100 for the safety of the operator or other personnel and to protect equipment from damage. For example, the active position of the safety switch 432 means the safety procedures have been implemented by stopping the drawworks using the electric motor 140 and other ongoing rig operations. Operations that may be stopped by the control system 400 include stopping rotation of the electric motor 140 and the drum 122 using a first braking system 135 and optionally, followed by activating a second braking system 137 or stopping rotation of any rotary table or top drive activities or other rig activities. In some embodiments, the safety switch 432 may be part of a control lever, such as a joystick 430, which allows an operator to select input into the control system 400. The safety switch 432 may be placed in the inactive position only by an intentional action of the operator using a hand on or touching the joystick 430. The safety switch 432 remains in the inactive position until the operator removes his hand or part of his hand on the joystick 430. In some examples, the safety switch 432 remains in the inactive position until the operator's hand or part of the hand is no longer pressing the safety switch 432. In one example, the safety switch 432 remains in the inactive position until the operator's hand is removed from the joystick 430, either intentionally or unintentionally.

In some embodiments, the safety switch 432 is an on/off type of switch and may be biased towards the active position. In the active position, the safety switch 432 will signal to the control system 400 to implement safety procedures. In one example, a safety procedure implemented by activation of the safety switch 432 is a full stop of the drum 122 using the electric motor 140, as will be discussed in more detail below. Other safety features implemented by the safety switch in the active position include stopping of any rotating or moving device or operation on the service rig 100. An operator can place the safety switch 432 in the inactive position by intentionally overcoming the bias towards the active position. In some embodiments, if the safety switch 432 is not intentionally moved to the inactive position, then the safety switch 432 will remain in the active position. In some embodiments, the safety switch 432 is located on the joystick 430, such as on a distal end of the joystick 430. In this respect, when an operator's hand is on or in close proximity to the joystick 430, the thumb or a finger of that hand is able to place the safety switch 432 in the inactive position, usually by pressing on the safety switch 432. The safety switch 432 may be pressed by the hand to overcome the bias of the safety switch 432 to the active position. In some embodiments, the safety switch 432 may be a gripping or touching type of switch that senses a gripping force or touching contact of an operator's hand to place the safety switch 432 in the inactive position. In some embodiments, the safety switch 432 is configured to detect the presence of the operator, such as including a proximity sensor. In some examples, the safety switch 432 can detect the operator (such as the operator's hand) when the operator is within from 0.1 inches to 4 inches or from 0.1 to 2 inches of the safety switch 432. It is contemplated that any form of switch that could be automatically moved or placed in an active position, starting safety procedure implementation, either electronically or mechanically, either intentionally or unintentionally, from an inactive position by removal of the operator's hand or part of the hand from the joystick 430 and could be placed in an inactive position by the intentional presence or force of the operator's hand or part of the hand is within the scope of the disclosure. The service rig 100, equipped with the electric motor 140 powering the drawworks 120, may include the safety switch 432 to automatically implement safety measures to protect personnel and equipment on the rig.

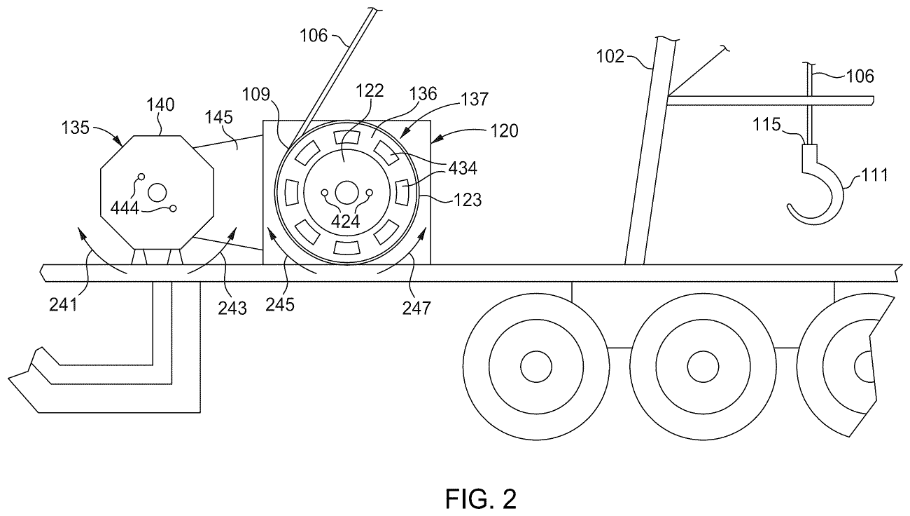

FIG. 1 illustrates an exemplary embodiment of a service rig 100 including a service trailer 80. FIG. 2 is an enlarged, partial view of the rig 100. The drawworks 120, including the rotatable drum 122 is powered by the electric motor 140 to wind and unwind a cable 106. A gearbox 145 is operatively and rotationally connected to and located between a motor shaft 126 of the electric motor 140 and a drum shaft 125 of drum 122. The gearbox 145 may include multiple gears rotationally connected to each other. The service rig 100 also includes a derrick 102 having a crown block 108 and a hook 111 attached to an end of the cable 106 to raise or lower devices (not shown) in the derrick 102. A load sensor 115 may be attached to the hook 111, integral with the cable 106 above the hook 111, or located in the crown block 108 to measure the weight on the hook 111. The load sensor 115 outputs data to the control system 400 and converted, if necessary, to the amount of tension on the cable 106. A distal end 109 of the cable 106 opposite the hook 111 is fixably attached to the rotatable drum 122 of the drawworks 120. The rig 100 may include one or more load sensors 115 located between the hook 111 and the distal end 109 of the cable 106. The cable 106 passes through a crown block 108 located towards the top of derrick 102.

The electric motor 140 may rotate in a first rotational direction 241 which will cause the drum 122 to rotate in a first rotational direction 245 through the gearbox 145. The electric motor 140 may rotate in a second rotational direction 243 opposite the first rotational direction 241 which will cause the drum 122 to rotate in a second rotational direction 247 opposite the first rotational direction 245 through the gearbox 145. The first rotational direction 241 of the electric motor 140 may be in the same direction or different direction as the first rotational direction 245 of the drum 122.

As the drum 122 rotates about the drum shaft 125, the cable 106 winds or unwinds around a cylindrical surface 123 of the drum 122, depending on the rotational direction of the drum 122. When the drum 122 rotates in the first rotational direction 245, the cable 106 unwinds from the cylindrical surface 123 of the drum 122, and the hook 111 moves vertically downward in the derrick 102. When the drum 122 rotates in the second rotational direction 247, opposite the first rotational direction 245, the cable 106 winds around the cylindrical surface 123 of the drum 122, and the hook 111 moves vertically upward in the derrick 102. The cylindrical surface 123 may have spiral grooves to facilitate alignment of the cable 106 during winding or unwinding. As the cable 106 winds or unwinds around the cylindrical surface 123, the hook 111 moves up or down vertically in the derrick 102, respectively. The rotational speed and/or braking force of the electric motor 140 is selected by an operator by movement of the joystick 430 described in more detail below.

In response to the selective positioning of the joystick 430 by an operator and the position of the safety switch 432, the control system 400 supplies the appropriate amount of current to the electric motor 140, which in turn applies a resultant torque for the desired rotational speed, for braking, for stopping, or for controlling direction of the drum 122, as explained in detail below. The amount of current supplied to the electric motor 140 with the corresponding resultant torque may be based on input from rotational sensors on the electric motor 140 and the drum 122 and load sensor 115. In some embodiments, the control system 400 may advantageously use the kinetic energy of the unwinding cable 106 to operate the electric motor 140. In this respect, the electric motor 140 is transformed into an electrical generator so that little or no current would have to be supplied to the electric motor 140 for a rotational speed selected by movement of the joystick 430.

In some embodiments, an operator inputs the desired commands using the joystick 430 at a control panel 310, as shown in FIG. 3. The control panel 310 may include a housing 311 that at least partially encloses the control panel 310. The control panel 310 may have a display 339 that would provide information regarding operation of the rig 100. In some embodiments, the rotation of the electric motor 140 is measured using at least one rotational sensor 444 on the electric motor 140, using at least one rotational sensor 424 on the drum 122, or using both.

The joystick 430 has a zero position 332 and variable positions that may follow an arcuate path 333 away from the zero position 332. The arcuate path 333 may have a first arcuate limit 336 in a first arcuate direction 335 and a second arcuate limit 338 in a second arcuate direction 337. The zero position 332 may be located towards the middle of the arcuate path 333. The joystick 430 may be biased to the zero position 332 using a biasing mechanism, such as one or more springs, not shown. When the joystick 430 is in the zero position 332, the control system 400 is instructed to brake and stop rotation of the electric motor 140 using an appropriate amount of torque based on the tension in the cable 106 as a result of the weight on the hook 111. The weight on the hook 111 is measured by the load sensor 115 and sent to the control system 400. Input from the at least one senor 444 and/or the at least one sensor 424 may indicate to the control system 200 that the electric motor 140 and drum 122 are slowing or have stopped. If rotational sensors 444, 424 do not detect rotation, then the appropriate amount of current with resultant torque has been applied to the electric motor 140 to hold the drum 122 in a stopped position.

As the joystick 430 is moved in the first arcuate direction 335 away from the zero position 332, the control system 200 is instructed to cause the electric motor 140 to apply less torque which allows the electric motor 140 to rotate in a first rotational direction 241. In turn, the drum 122 rotates in a first rotational direction 245 to unwind the cable 106 from the cylindrical surface 123 of the drum 122, thereby lowering the hook 111. As discussed above, the amount of torque applied by the electric motor 140 is based on the amount of current supplied to the electric motor 140. As the joystick 430 is moved further away from the zero position 332 in the first arcuate direction 335 towards the first travel limit 336, the amount of current applied to the electric motor 140 is further reduced, resulting in greater rotational speed for the electric motor 140 and the drum 122. In some embodiments, the control system 400 may include programmed rotational travel limits for the drum 122 based on data from sensors 424, 444 to limit the amount of drum rotation in the first rotational direction 245. In this respect, the travel limits of the drum 122 will, in turn, limit the travel of the hook 111, as the hook is lowered in the derrick 102. The travel limits of the drum 122 may be effective even if the joystick 430 is in the first arcuate direction 335 away from the zero position 332. In some embodiments, the control system 400 may include other programmed rotational threshold limits that automatically slow the motor rotational speed and before the travel limits mentioned above are reached.

As the joystick 430 is moved in the second arcuate direction 337 opposite the first arcuate direction 335 and away from the zero position 332, the control system 400 is instructed to apply appropriate current to the electric motor 140 to rotate the electric motor 140 in the second rotational direction 243 and the drum 122 in the second rotational direction 247 opposite the first rotational directions 241, 245. As a result, the cable 106 winds up around the cylindrical surface 123. As the joystick 430 is moved further away from the zero position 332 in the second arcuate direction 337, the amount of current applied to the electric motor 140 and resultant torque by the electric motor 140 is increased, resulting in greater rotational speed for the electric motor 140 in the second rotational direction 243. In some embodiments, the control system 400 may include programmed rotational travel limits for the drum 122 based on data from sensors 424, 444 to limit the amount of drum rotation in the second rotational direction 247. In this respect, the travel limits of the drum 122 will, in turn, limit the travel of the hook 111 as the hook is raised in the derrick 102. The travel limits of the drum 122 may be effective even if the joystick 430 is in the second arcuate direction 375 away from the zero position 332. In some embodiments, at least one proximity sensor may be located in the derrick to detect hook position and limit hook travel even though the joystick 430 is in the first or second arcuate directions 335, 337 and not in the zero position 332. The first arcuate direction 335 and the second arcuate direction 337 of the joystick 430 have a maximum physical limit in both arcuate directions, specifically a first limit 336 and a second limit 338, respectfully.

In some embodiments, the rig 100 includes two braking systems for braking the drum 122 such as a first braking system 135 and a second braking system 137. One or both of braking systems 135, 137 may be controlled by the control system 400 or manually controlled. In one example, the first braking system 135 includes an electrical braking system. In this example, the first braking system 135 uses the torque of the electric motor 140 to control the rotational speed of the drum 122 via the gearbox 145. The electrical, first braking system 135 is used by the service rig 100 to perform rig operations involving raising or lowering the hook, and the safety switch 432 is pressed to place the switch 432 in the inactive position. By controlling the current, the appropriate amount of torque is produced by the electric motor 140, and the rotational speed of the drum 122 can be slowed, stopped, or held in a stopped position. As part of the first braking system 135, controlled by the control system 400, the kinetic energy of the falling cable 106, hook 111 plus any devices attached to the hook 111 is used to generate electricity with the electric motor 140. The generated electricity is dissipated into resistors. The rotational speed of the electric motor 140 is slowed by the kinetic energy of the falling cable 106 and weight on the hook 111 being transformed into electrical energy generation. Real time input of the rotational speed from the rotational sensors 444, 424 and the load sensor 115 is used by the control system 400 to calculate the required torque by the electric motor 140 or the resisting electrical generation according to need by the position of the joystick 430.

The second braking system 137 may slow or stop rotation of the drum 122 and thus the rate at which the cable 106 is wound and unwound from the drum 122. The second braking system 137 may be used as a backup braking system in the event of a malfunction of the first braking system 135. In some embodiments, the second braking system 137 may be used as a longer term braking system, taking over operation of the first braking system 135 when longer periods of stopping are desired. In some examples, the second braking system 137 may lock the drum 122 in a locked state to prevent any movement in either rotational direction. The second braking system 137 may be operated by either the control system 400 or manually by the operator.

In some embodiments, the second braking system 137 includes a mechanical system that is biased toward a braked, activated mode 138, as shown in FIG. 5. In one embodiment of the activated mode 138, one or more springs 431 apply a biasing force to one or more friction pads 434, which causes the friction pads 434 to contact a braking surface 136 with sufficient force to slow, stop, and/or lock the drum 122. In one example, the second braking system 137 includes a plurality of springs 431 and a plurality of friction pads 434. In some examples, the braking surface 136 may be on the drum 122. In some examples, the braking surface 136 may be on another component of the drawworks 120, the gearbox 145, or the electric motor 140.

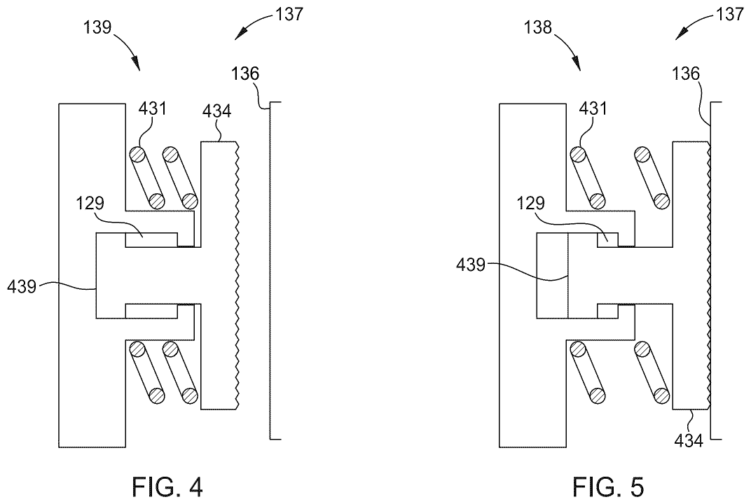

The second braking system 137 also includes an unbraked, inactivated mode 139, as shown in FIG. 4. In some embodiments, the second braking system 137 includes a powered system 129 to counteract the effects of the springs 431. In some examples, the powered system 129 includes a piston 439 utilizing pneumatic or hydraulic pressure configured to provide an adequate amount force to overcome the biasing force of the spring 431. In the inactivated mode 139, the powered system 128 retracts the friction pads 434 and holds the friction pads 434 away from the braking surface 136, thereby allowing the drum 122 to rotate. It is noted that any mechanical braking system that is biased to the braked, activated mode 138 and powered to the unbraked, inactivated mode 139 is within the scope of this disclosure. In some embodiments, the control system 400 may beneficially control both the electric first braking system 135 and the mechanical second braking system 137 in operational harmony to control braking of the drum 122.

In some embodiments, operation of the drawworks 120 may start with maintaining the drum 122 in a non-rotational state by using the mechanical second braking system 137 in the activated mode 138. The control system 400 keeps the second braking system 137 activated with the drum 122 locked from turning and keeps the electrical first braking system deactivated. The electric motor 140 is in a stopped position with no torque, and the electrical first braking system 135 is not applying (e.g., contributing) any braking or locking force to the drum 122. As part of the operation of the drawworks 120 startup for rig operations, the joystick 430 would be in the zero position 332. Also, during startup, even though the safety switch 432 would be in an unpressed or active position with the operator's hand off, the first braking system is not activated.

To instruct the control system 400 to activate the first braking system 135 and inactivate the second braking system, the operator places the safety switch 432 in the inactive position (e.g., pressed position) using the hand or part of the hand, thereby overcoming the bias of the safety switch 432 to the active position. The control system 400 activates the first braking system 135 to apply sufficient power to the electric motor 140 and resultant torque to hold the drum 122 in a stopped position based on the weight on the hook 111 as given by the output of the load sensor 115. The control system 400 changes the second braking system 137 from the activated mode 138 to the inactivated mode 139 such that the second braking system 137 has no contribution to the locking or braking of the drum 122. The operator may now start rotation of the drum 122 in either rotational direction 245, 247 by moving the joystick 430 in the first arcuate direction 335 or the second arcuate direction 337. The joystick 430 instructs the control system 400 to move the electric motor 140 in response to the position of the joystick 430. During operation, the operator keeps the hand or part of the hand on the safety switch 432 to keep the safety switch 432 in the inactive position. In some embodiments, slowing and stopping the rotational speed of the electric motor 140 and the drum 122 is performed by the first braking system 135 alone without the second braking system 137.

Any time the operator's hand or part of the hand moves off of or sufficiently far away from the joystick 430, the safety switch 432 will beneficially move to the active position. In turn, the control system 400 will automatically slow down and stop rotation of the electric motor 140 by causing the first braking system 135 to apply the appropriate amount of torque for the current tension on the cable 106, as read by the load sensor 115. In some examples, the movement of the safety switch 432 from the inactive position to the active position may have been inadvertent or due to the operator falling, operator fatigue, the operator getting distracted or any reason that may have taken full attention away from the drawworks operation. In order to resume rig operations of winding or unwinding the cable 106, the joystick 430 must be moved to the zero position 332 before the safety switch 432 can once again be placed in the inactive position, thereby allowing rotation of the electric motor 140 and drum 122.

Rig operation may continue until the operator intentionally stops the rotation of the drum 122 by moving the joystick 430 to the zero position 332, which activates the first braking system 135, and then removing the operator's hand from the joystick 430 to cause the safety switch 432 to automatically move to the active position. After the drum 122 has been stopped by the activation of the first braking system 135 by the control system 400, and there is no drum rotational activity for a predetermined period of time and the safety switch 432 is in the active position (e.g., unpressed position), the control system 400 will activate the second braking system 137 and deactivate the first braking system 135. In some examples, the predetermined period of time after which the second braking system 137 is activated and first braking system 135 is deactivated may be in a range from 0 seconds to 10 minutes, such as from 30 seconds to 7 minutes, such as 1 minute or 3 minutes. In some examples, the amount of time between the stopping of the drum 122 by the first braking system 135 and transferring the braking to the second braking system 137 for long term stopping is from 4 minutes to 6 minutes, such as 5 minutes. The amount of time before the transfer may be changed by changing the programming in the control system 400.

In one embodiment, rotation of the drum 122 retracts or pays out a cable 106 that is attached to a traveling block, thereby moving the traveling block (not shown). A control system 400 controls operation of the drum 122 by operating the electric motor 140. The control system 400 actuates a brake to lock the drum against rotation in response to determining a load borne by the cable exceeds a threshold value for a preset length of time while the traveling block is not moving.

In some embodiments, a method of operating a rig includes maintaining a drum of the rig in a non-rotational state. The method also includes moving a safety switch to an inactive position to activate a first braking system, and then a joystick is moved to rotate the drum. The method further includes moving the safety switch to an active position to cause the first braking system to apply sufficient torque to slow down rotation of the drum. After slowing down the drum, the first braking system is used to retain the drum in the non-rotational state. After a predetermined period to time, a second braking system is activated to retain the drum in the non-rotational state, and the first braking system is deactivated. Before reactivating the first braking system, the joystick is returned to a neutral position.

In some embodiments, a method of operating a rig includes maintaining a drum of the rig in a non-rotational state. The method also includes moving a safety switch to an inactive position to activate a first braking system, and rotating the drum by moving a joystick. The method also includes moving the safety switch to an active position to cause the first braking system to stop rotation of the drum.

In some embodiments, a method of operating a rig includes maintaining a drum of the rig in a non-rotational state. The method also includes moving a safety switch to an inactive position to activate a first braking system and inactivate a second braking system. The drum is rotated by moving a joystick. The safety switch is moved to an active position to cause the first braking system to apply sufficient current with resultant torque to slow down rotation of the drum.

In one or more embodiments, moving the safety switch to the active position comprises unintentionally moving the safety switch to the active position.

In one or more embodiments, unintentionally moving the safety switch comprises applying an insufficient grip pressure on the joystick or removing manual contact with the joystick.

In one or more embodiments, the drum is maintained in the non-rotational state by using a second braking system.

In one or more embodiments, the joystick is in a neutral position when the drum is in the non-rotational state.

In one or more embodiments, moving the joystick comprises moving the joystick away from the neutral position.

In one or more embodiments, the activated first braking system holds the drum in the non-rotational state.

In one or more embodiments, activating the first braking system causes a second braking system to change to the inactivated mode.

In one or more embodiments, after slowing down the drum, the method further comprises using the first braking system to maintain the drum in the non-rotational state.

In one or more embodiments, the method includes activating the second braking system to maintain the drum in the non-rotational state.

In one or more embodiments, the method includes moving the joystick to a neutral position while maintaining the drum in the non-rotational state.

In one or more embodiments, the first braking system comprises an electrical braking system.

In one or more embodiments, the second braking system comprises a mechanical braking system.

In one or more embodiments, the second braking system comprises a powered system having a piston and a friction pad coupled to the piston.

In one or more embodiments, the safety switch is biased to the active position.

In one or more embodiments, the safety switch is biased to the active position using a spring.

In one or more embodiments, the safety switch is on the joystick.

In one or more embodiments, moving the safety switch to the inactive position comprises contacting the safety switch while holding the joystick.

In one or more embodiments, the method includes maintaining contact with the safety switch while rotating the drum.

In one or more embodiments, rotating the drum retracts or pays out a cable that is attached to a traveling block.

In one or more embodiments, rotating the drum by moving a joystick comprises operating a motor to rotate the drum.

In one or more embodiments, the safety switch is moved to an active position in response to determining a load borne by the cable exceeds a threshold value for a preset length of time while the traveling block is not moving.

It is contemplated that any one or more elements or features of any one disclosed embodiment or example may be beneficially incorporated in any one or more other non-mutually exclusive embodiments or examples. While the foregoing is directed to embodiments of the present disclosure, other and further embodiments of the disclosure may be devised without departing from the basic scope thereof, and the scope thereof is determined by the claims that follow.

What is claimed is:

1. A method of operating a rig, comprising:
maintaining a drum of the rig in a non-rotational state;
moving a safety switch to an inactive position to activate a first braking system;
rotating the drum by moving a joystick; and
moving the safety switch to an active position to cause the first braking system to stop rotation of the drum.

2. The method of claim 1, wherein moving the safety switch to the active position comprises unintentionally or intentionally moving the safety switch to the active position.

3. The method of claim 2, wherein unintentionally moving the safety switch comprises applying an insufficient grip pressure on the joystick or removing manual contact with the joystick.

4. The method of claim 1, wherein the drum is maintained in the non-rotational state by using a second braking system.

5. The method of claim 1, wherein the joystick is in a neutral position when the drum is in the non-rotational state.

6. The method of claim 5, wherein moving the joystick comprises moving the joystick away from the neutral position.

7. The method of claim 1, wherein the activated first braking system holds the drum in the non-rotational state.

8. The method of claim 7, wherein activating the first braking system causes a second braking system to change to an inactivated mode.

9. The method of claim 8, wherein after stopping the drum, the method further comprises using the first braking system to maintain the drum in the non-rotational state.

10. The method of claim 9, further comprising activating the second braking system to maintain the drum in the non-rotational state.

11. The method of claim 10, further comprising moving the joystick to a neutral position while maintaining the drum in the non-rotational state.

12. The method of claim 8, wherein the first braking system comprises an electrical braking system, and the second braking system comprises a mechanical braking system.

13. The method of claim 8, wherein the second braking system comprises a powered system having a piston and a friction pad coupled to the piston and a biasing mechanism.

14. The method of claim 1, wherein the safety switch is biased to the active position using a spring.

15. The method of claim 1, wherein the safety switch is on the joystick.

16. The method of claim 1, wherein moving the safety switch to the inactive position comprises contacting the safety switch while holding the joystick.

17. The method of claim 16, further comprising maintaining contact with the safety switch while rotating the drum.

18. The method of claim 1, wherein rotating the drum retracts or pays out a cable that is attached to a traveling block.

19. The method of claim 18, wherein rotating the drum by moving a joystick comprises operating a motor to rotate the drum.

20. The method of claim 19, wherein the safety switch is moved to an active position in response to determining a load borne by the cable exceeds a threshold value for a preset length of time while the traveling block is not moving.
